(19) United States
(12) Patent Application Publication
(10) Pub. No.: US 2022/0035612 A1
(43) Pub. Date: Feb. 3, 2022

(54) CONVERSION ASSISTANCE PROGRAM, CONVERSION ASSISTANCE METHOD, AND CONVERSION ASSISTANCE DEVICE

(71) Applicant: FUJITSU LIMITED, Kawasaki-shi (JP)

(72) Inventors: Takashi Ohata, Fujinomiya (JP); Takamasa Uramoto, Numazu (JP); Takashi Yamamoto, Shizuoka (JP)

(73) Assignee: FUJITSU LIMITED, Kawasaki-shi (JP)

(21) Appl. No.: 17/384,029

(22) Filed: Jul. 23, 2021

(30) Foreign Application Priority Data
Aug. 3, 2020 (JP) 2020-131862

(51) Int. Cl. G06F 8/51; G06F 8/73

(52) U.S. Cl. CPC G06F 8/51; G06F 8/73

(57) ABSTRACT

A non-transitory computer-readable medium storing a conversion assistance program that causes at least one computer to execute a process, the process includes embedding an identifier that identifies a line position of a code line of a source code in the source code, in a form that does not affect a conversion result of a conversion tool that converts the source code; and generating relationship information that indicates whether or not there is a change from the code line of the source code to the code line of a post-conversion source code generated by converting a post-embedding source code, which is the source code after the identifier is embedded, using the conversion tool; an addition of the code line to the source code; or a deletion of the code line from the source code, based on the post-conversion source code and the source code.

### CROSS-REFERENCE TO RELATED APPLICATION

This application is based upon and claims the benefit of priority of the prior Japanese Patent Application No. 2020-131862, filed on Aug. 3, 2020, the entire contents of which are incorporated herein by reference.

### FIELD

The embodiments discussed herein are related to a conversion assistance program, a conversion assistance method, and a conversion assistance device.

### BACKGROUND

There is a conversion tool that converts a part of a source code description, Here, “tool” refers to a program. For example, a preprocessor accepts an input of a source code in which a macro that is not allowed to be directly processed by a compiler is embedded, to expand the macro and convert the expanded macro into a source code that can be processed by the compiler, and outputs the converted macro. FIG. 17 is a diagram for explaining a preprocessor as an example of the conversion tool. As illustrated in FIG. 17, in the pre-conversion source code, “TAX_RATE” is defined as “1.08” by the define macro. A preprocessor 91 converts “return val TAX_RATE” to “return val*1.08”.

In such a conversion tool, it is useful to manage correspondence information between line positions before and after the conversion. For example, a compiler 3 can point out a compilation error only for the source code line after conversion if there is no correspondence information between line positions, but if there is correspondence information between line positions, can point out a compilation error by converting the line position after conversion to the line position before conversion. Since a user edits the pre-conversion source code, pointing out a compilation error with regard to the line position of the pre-conversion source code makes it easier for the user to understand. Similarly, also in source level debugging, performing a debug operation with regard to the line position of the pre-conversion source code by using the line position correspondence information makes it easier for the user to operate.

As an example of the method of creating the line position correspondence information, there is a method using a directive for the C preprocessor and some COBOL precompilers (here, a #LINE approach is assumed). FIG. 18 is a diagram for explaining the #LINE approach. As illustrated in FIG. 18, in the #LINE approach, a conversion tool 92 inserts the line position correspondence information into the output source code using a special directive #LINE.

In FIG. 18, “EXEC SQL . . . ” is converted to “CALL “Connect””. “EXEC SQL.” before conversion is output as a comment with “*” attached. The conversion tool 92 outputs “#LINE 2 start” before “CALL “Connect”” and “#LINE 2 end” after “CALL “Connect”” to indicate that “CALL “Connect”” corresponds to the second line before conversion.

When outputting an error, if the directive #LINE is prepared, the compiler 3 corrects line information to output an error message. In FIG. 18, the compiler 3 detects a compilation error on the fourth line of the source code after conversion, but outputs that there is a compilation error on the second line of the source code, based on the directives before and after the detection location.

Some conversion tools do not output the line position correspondence information of the #LINE approach. Even when the conversion tool does not output the line position correspondence information of the #LINE approach, the compiler 3 will be allowed to utilize the line position correspondence information in line with the #LINE approach, if #LINE can be properly inserted in a source code file after conversion.

As a method of inserting #LINE, there is a method of using an insertion tool that specifies the correspondence between line positions using difference information between the source code files before and after the conversion and inserts #LINE into the source code file after conversion. FIG. 19 is a diagram for explaining the insertion tool. As illustrated in FIG. 19, the conversion tool 93 converts “EXEC SQL . . . ” in a file A to “CALL “Connect” and outputs the conversion result to a file A′. Then, an insertion tool 94 accepts an input of the file A′ to insert “#LINE 2 start” before “CALL “Connect”” and “#LINE 2 end” after “CALL “Connect”” and outputs the insertion result to a file A”.

Examples of the related art include Japanese Laid-open Patent Publication No. 09-22346.

### SUMMARY

According to an aspect of the embodiments, a non-transitory computer-readable medium storing a conversion assistance program that causes at least one computer to execute a process, the process includes embedding an identifier that identifies a line position of a code line of a source code in the source code, in a form that does not affect a conversion result of a conversion tool that converts the source code; and generating relationship information that indicates whether or not there is a change from the code line of the source code to the code line of a post-conversion source code generated by converting a post-embedding source code, which is the source code after the identifier is embedded, using the conversion tool; an addition of the code line to the source code; or a deletion of the code line from the source code, based on the post-conversion source code and the source code.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for explaining a process by a conversion assistance device according to an embodiment;

FIG. 2 is a diagram illustrating a functional configuration of the conversion assistance device according to the embodiment;

FIG. 3 is a diagram illustrating an example of embedding input line identifiers;

FIG. 4 is a diagram illustrating an example of the input line identifiers;

FIG. 5 is a diagram illustrating an example of conversion by a conversion tool;

FIG. 6 is a diagram illustrating an example of input and output of a relationship information creation unit;

FIG. 7A is a diagram illustrating details of creating a relationship information table illustrated in FIG. 6 (when there is no change);

FIG. 7B is a diagram illustrating details of creating the relationship information table illustrated in FIG. 6 (when there is a change);

FIG. 7C is a diagram illustrating details of creating the relationship information table illustrated in FIG. 6 (when an addition is made);

FIG. 7D is a diagram illustrating details of creating the relationship information table illustrated in FIG. 6 (when a deletion is made);

FIG. 8 is a diagram illustrating an example of the relationship information table when the conversion tool expands the contents of a file designated by a macro;

FIG. 9 is a diagram illustrating an example of removing the input line identifiers;

FIG. 10 is a diagram illustrating an example of output of a correspondence information insertion unit;

FIG. 11 is a diagram illustrating an example when the contents of a SUB.cob file are expanded;

FIG. 12 is a diagram illustrating an example of error display on an input file line by a compiler;

FIG. 13 is a diagram for explaining source code level debugging by a debugger;

FIG. 14A is a flowchart illustrating a flow of a process by the relationship information creation unit (when a process other than deletion of a line is performed by the conversion tool);

FIG. 14B is a flowchart illustrating a flow of a process by the relationship information creation unit (when deletion of a line is performed by the conversion tool);

FIG. 15 is a flowchart illustrating a flow of a process by the correspondence information insertion unit;

FIG. 16 is a diagram illustrating a hardware configuration of a computer that executes a conversion assistance program according to the embodiment;

FIG. 17 is a diagram for explaining a preprocessor as an example of the conversion tool;

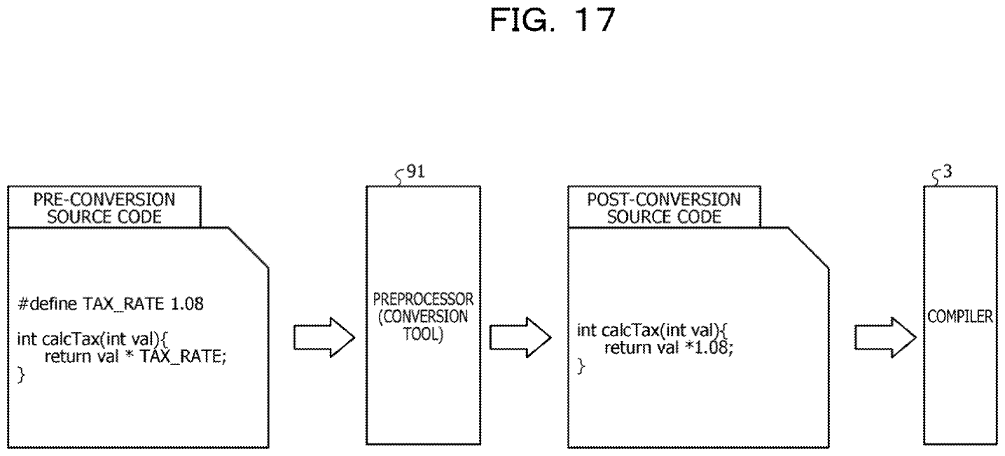

FIG. 18 is a diagram for explaining a #LINE approach;

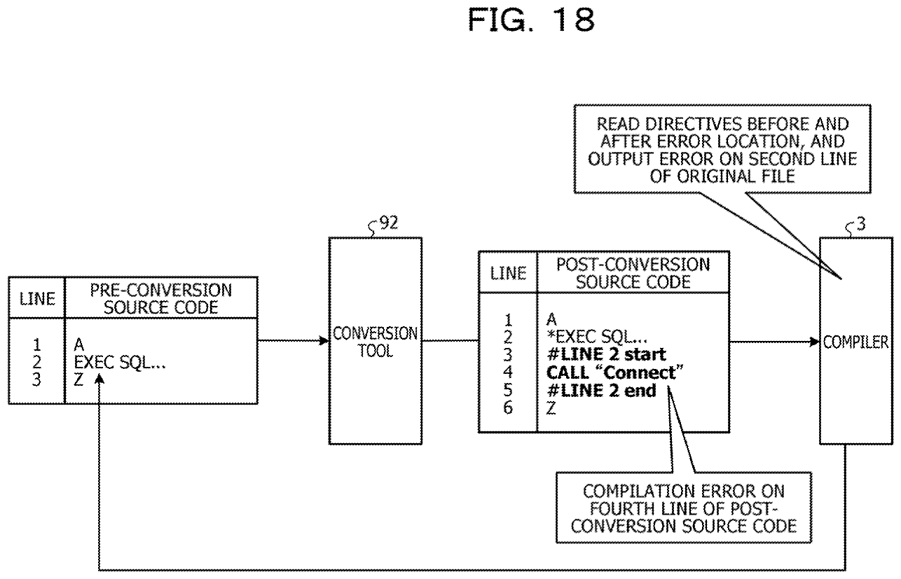

FIG. 19 is a diagram for explaining an insertion tool; and

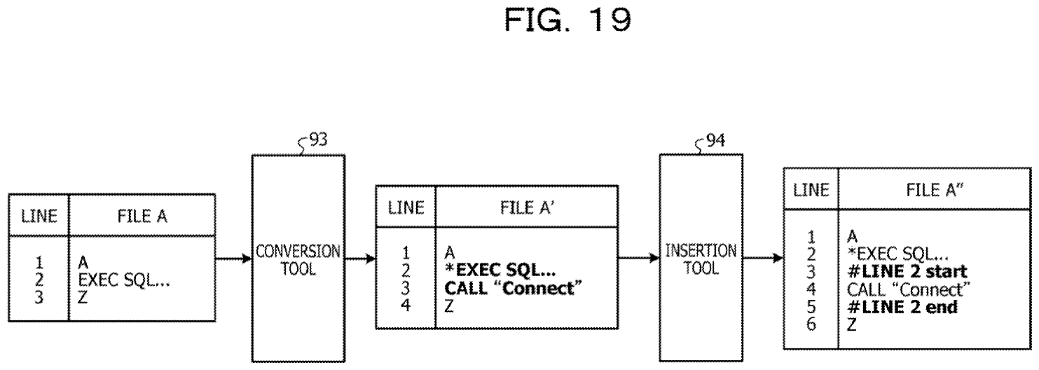

FIG. 20 is a diagram illustrating an example in which line position correspondence information may not be accurately created.

### DESCRIPTION OF EMBODIMENTS

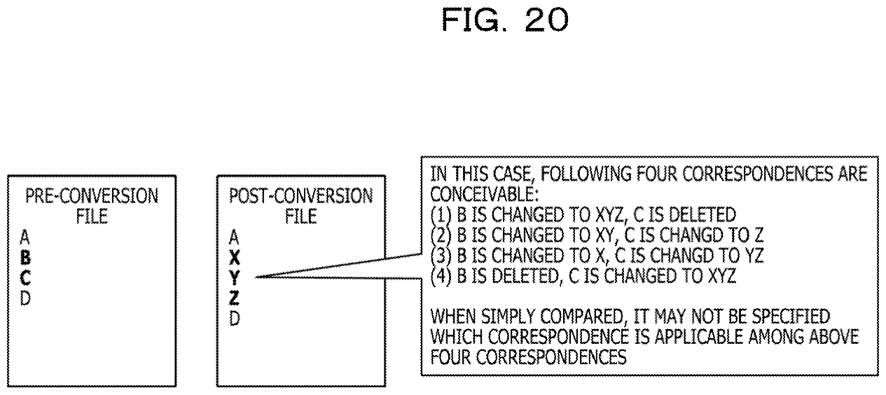

Since the insertion tool 94 simply compares the files before and after the conversion with each other to create the line position correspondence information, there is a disadvantage that the line position correspondence information may not be created accurately. FIG. 20 is a diagram illustrating an example in which the line position correspondence information may not be accurately created. In FIGS. 20, B and C are converted to X, Y and Z. In this case, since there are the following four correspondences between B and C and X, Y, and Z, the insertion tool 94 may not accurately create the line position correspondence information.

(1) B is changed to XYZ, and C is deleted

(2) B is changed to XY, and C is changed to Z

(3) B is changed to X, and C is changed to YZ

(4) B is deleted, and C is changed to XYZ

In one aspect, an object of the embodiment is to accurately create line position correspondence information between source codes before and after conversion.

Hereinafter, embodiments of a conversion assistance program, a conversion assistance method, and a conversion assistance device disclosed in the present application will be described in detail with reference to the drawings. Note that the present embodiments do not limit the technology disclosed.

### EMBODIMENTS

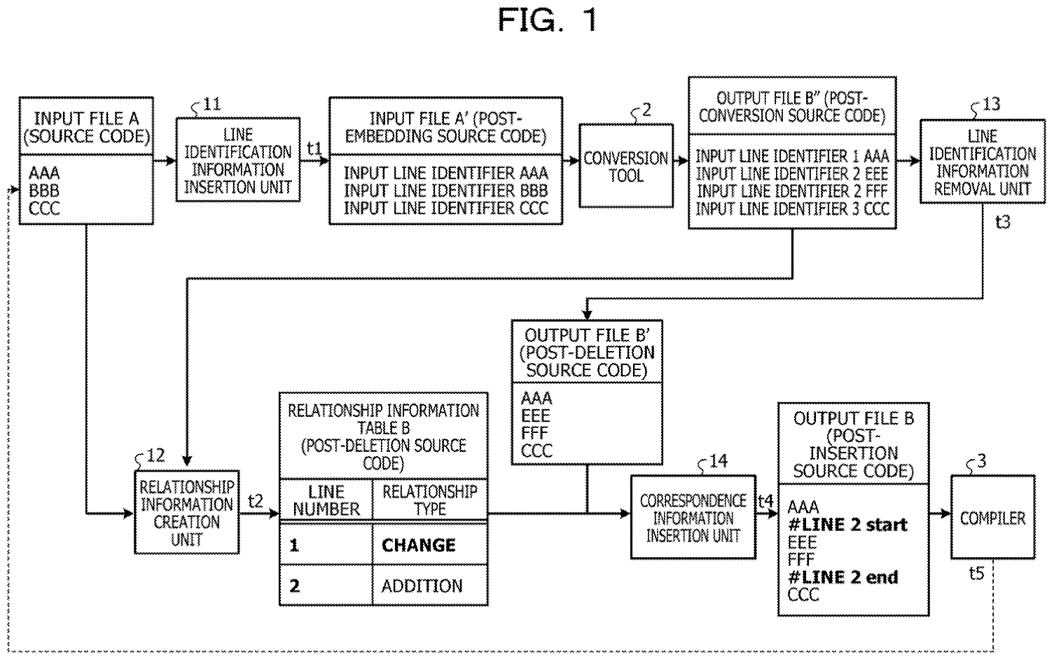

First, a process by a conversion assistance device according to an embodiment will be described. FIG. 1 is a diagram for explaining a process by the conversion assistance device according to the embodiment. As illustrated in FIG. 1, a line identification information insertion unit 11 reads an input file A (source code) and generates an input file A′ (post-embedding source code) in which input line identifiers containing information for identifying the file and line number information are embedded (t1). The input file Kis converted to an output file B″ (post-conversion source code) by a conversion tool 2.

Then, a relationship information creation unit 12 of the conversion assistance device according to the embodiment creates relationship information indicating an accurate relationship between before and after the conversion by the conversion tool 2 using the output file B″ and the input file A as inputs, and generates a relationship information table B (t2). Furthermore, a line identification information removal unit 13 of the conversion assistance device according to the embodiment removes the input line identifiers embedded in the output file B″ and generates an output file B′ (post-deletion source code) (t3). Note that this process by the line identification information removal unit 13 may not be conducted.

Then, a correspondence information insertion unit 14 of the conversion assistance device according to the embodiment generates an output file B (post-insertion source code) into which line position correspondence information has been inserted based on the relationship information table B and the output file B′ (t4). Then, the compiler 3 reads the output file B to compile the output file B, and displays an error message on the line of the input file A (t5).

In this manner, since the relationship information creation unit 12 generates the relationship information table B, and the correspondence information insertion unit 14 embeds the line position correspondence information based on the relationship information table B, the conversion assistance device according to the embodiment is allowed to embed accurate line position correspondence information.

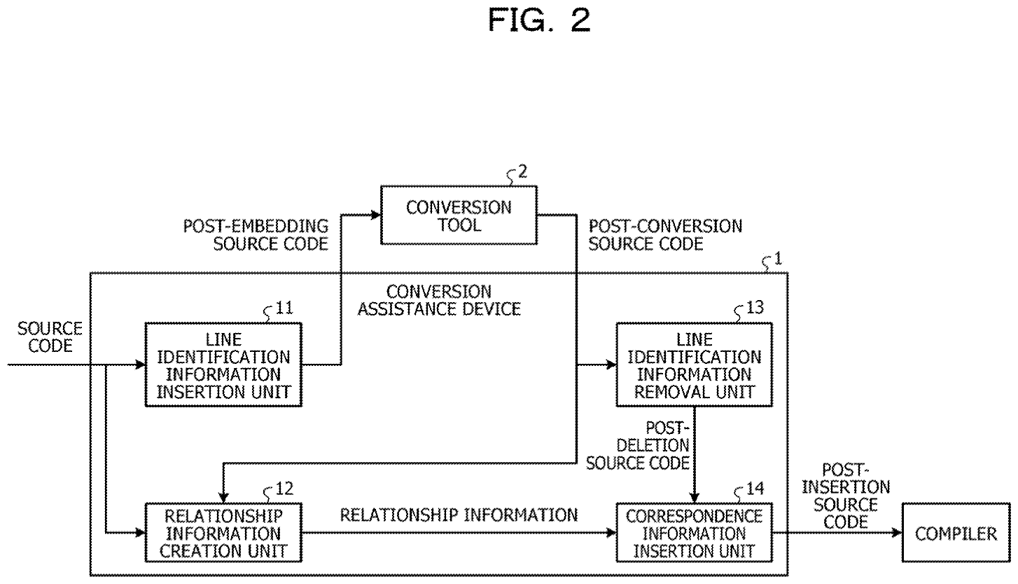

Next, a functional configuration of the conversion assistance device according to the embodiment will be described. FIG. 2 is a diagram illustrating a functional configuration of the conversion assistance device according to the embodiment. As illustrated in FIG. 2, the conversion assistance device 1 according to the embodiment includes the line identification information insertion unit 11, the relationship information creation unit 12, the line identification information removal unit 13, and the correspondence information insertion unit 14.

The line identification information insertion unit 11 reads a source code from a file to generate the post-embedding source code by embedding the input line identifier to be used for creating the line position correspondence information, and outputs the generated post-embedding source code to a file. Since the post-embedding source code in which the input line identifier is embedded is to be employed as the input of the conversion tool 2, the line identification information insertion unit 11 embeds the input line identifier in a format that does not affect the conversion result of the conversion tool 2.

For example, when the source code is described in COBOL, the line number area (the leftmost six columns of each line) is ignored at the time of conversion, and thus the line identification information insertion unit 11 inserts the input line identifier in the line number area. The input line identifier contains a file identifier for uniquely identifying a file to which each line (code line) belongs, and a line number for identifying each line. For example, when the input line identifier is inserted in the line number area of COBOL, the line identification information insertion unit 11 assigns the top two characters as the file identifier and the third to sixth characters as the line number.

When the source code is described in a language having an in-line comment function, such as the C language, the line identification information insertion unit 11 embeds the file name, the delimiter character, and the line number as comments.

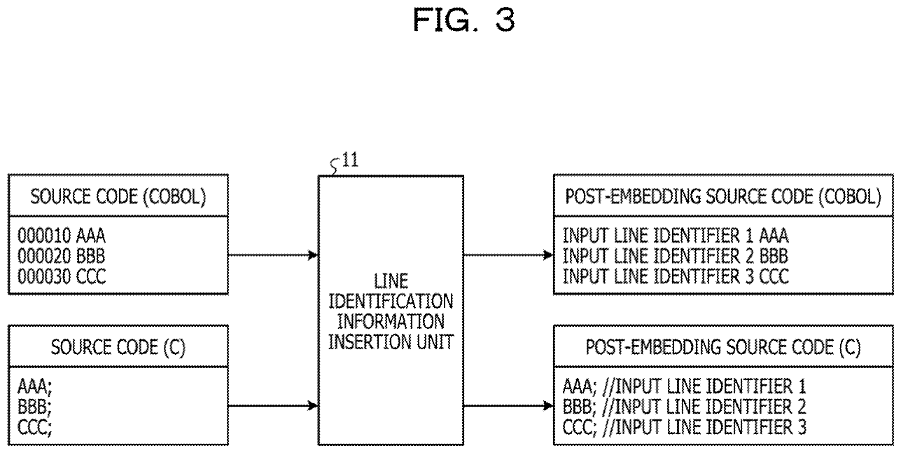

FIG. 3 is a diagram illustrating an example of embedding the input line identifiers. As illustrated in FIG. 3, when the source code is described in COBOL, the line identification information insertion unit 11 embeds “input line identifier 1” to “input line identifier 3” in the line number areas indicated by “000010” to “000030”. When the source code is described in the C language, the line identification information insertion unit 11 uses “//” indicating that an in-line comment follows to embed “input line identifier 1” to “input line identifier 3”.

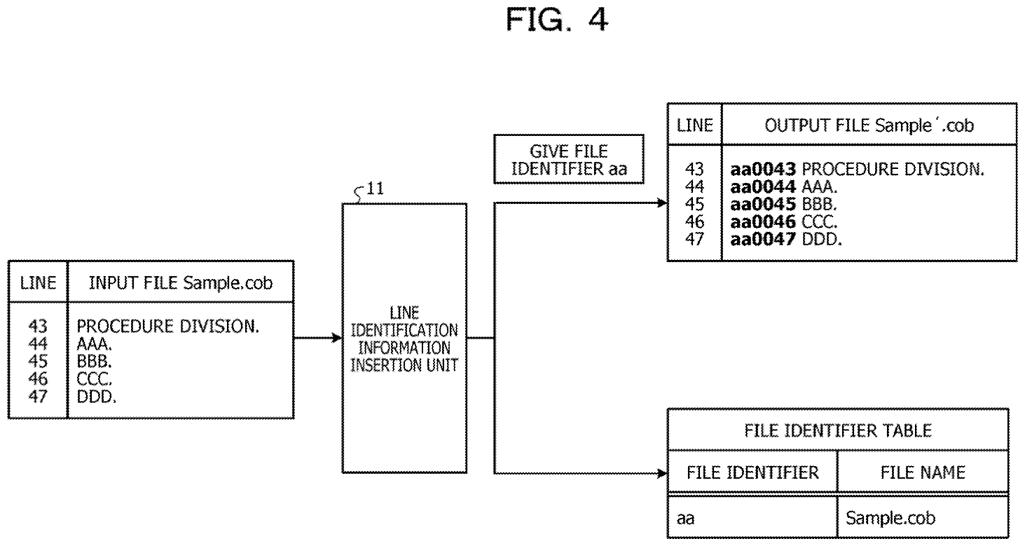

FIG. 4 is a diagram illustrating an example of the input line identifiers. As illustrated in FIG. 4, when the name of the input file that stores the source code is assumed as “Sample.cob”, the line identification information insertion unit 11 allocates the file identifier “aa” to “Sample.cob” because the file identifier is assigned with two characters. Then, the line identification information insertion unit 11 registers the file identifier and the file name in a file identifier table in association with each other. In FIG. 4, “aa” and “Sample.cob” are registered in the file identifier table in association with each other. Subsequently, the line identification information insertion unit 11 inserts the file identifier “aa” and the line number “0043” in the 43rd line of the source code.

Similarly, the line identification information insertion unit U inserts the file identifier “aa” and the line number “0044” in the 44th line of the source code, and inserts the file identifier “aa” and the line number “0045” in the 45th line of the source code. Similarly, the line identification information insertion unit 11 inserts the file identifier “aa” and the line number “0046” in the 46th line of the source code, and inserts the file identifier “aa” and the line number “0047” in the 47th line of the source code. Then, the line identification information insertion unit 11 outputs the post-embedding source code to a file Sample′.cob.

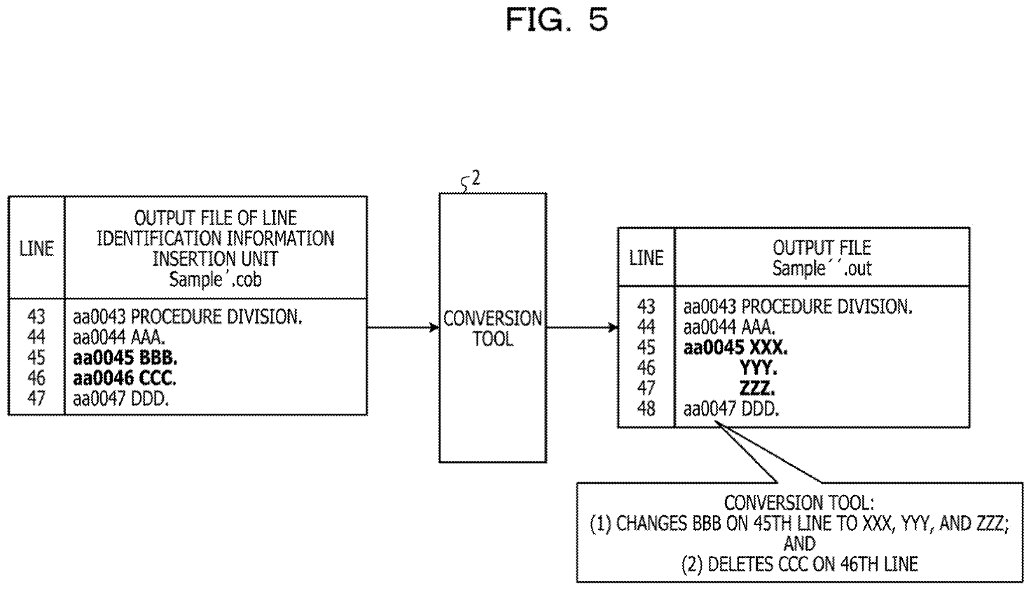

Returning to FIG. 2, the conversion tool 2 reads the post-embedding source code to perform a conversion process, and outputs the post-conversion source code. FIG. 5 is a diagram illustrating an example of conversion by the conversion tool 2. As illustrated in FIG. 5, the conversion tool 2 reads the output file Sample′.cob of the line identification information insertion unit 11 to perform a conversion process, and outputs a file Sample″.out. The conversion tool 2 changes the contents of the line while retaining line identification information. In FIG. 5, “BBB” on the 45th line is changed to “XXX”, “YYY”, and “ZZZ”, and “CCC” on the 46th line is deleted.

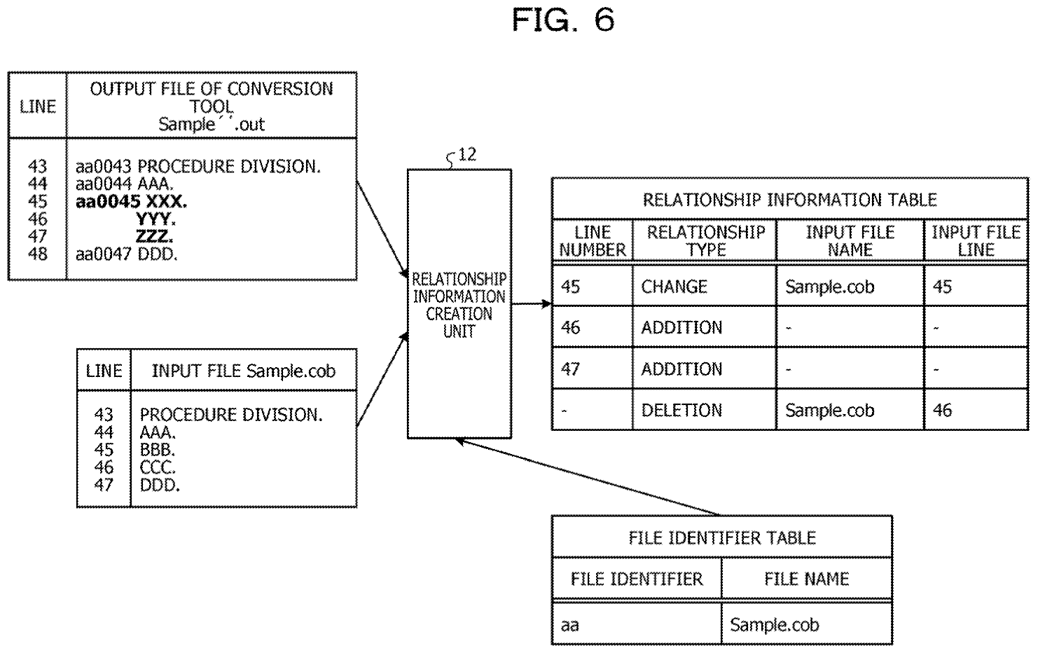

The relationship information creation unit 12 creates relationship information based on the source code and the post-conversion source code. FIG. 6 is a diagram illustrating an example of input and output of the relationship information creation unit 12. As illustrated in FIG. 6, the relationship information creation unit 12 reads the output file Sample″.out of the conversion tool 2 and the input file Sample.cob, and refers to the file identifier table to generate the relationship information table.

The relationship information table is a table in which relationship information that associates a line number, a relationship type, an input file name, and an input file line is registered. The line number is a number that identifies the line in the output file Sample″.out of the conversion tool 2.

The relationship type indicates a relationship from the perspective of the line of the output file Sample″.out of the conversion tool 2 with respect to the line of the input file Sample.cob. The relationship type denotes “change”, “no change”, “addition” or “deletion”. “Change” indicates that the line of the output file Sample″.out has been changed from the line of the input file Sample.cob “No change” indicates that the line of the output file Sample″.out has not been changed from the line of the input file Sample.cob. “Addition” indicates that the line of the output file Sample.out has been added to the input file Sample.cob. “Deletion” indicates that the line of the input file Sample.cob has been deleted.

The input file name denotes a name that identifies a file from which the line of the output file Sample“.out has been read. The input file line denotes a number that identifies the line of the input file Sample.cob.

For example, the 45th line of the output file Sample”.out is a line changed from the 45th line read from the input file Sample.cob. The 46th and 47th lines of the output file Sample“.out are lines added by the conversion tool 2. The 46th line read from the input file Sample.cob has been deleted.

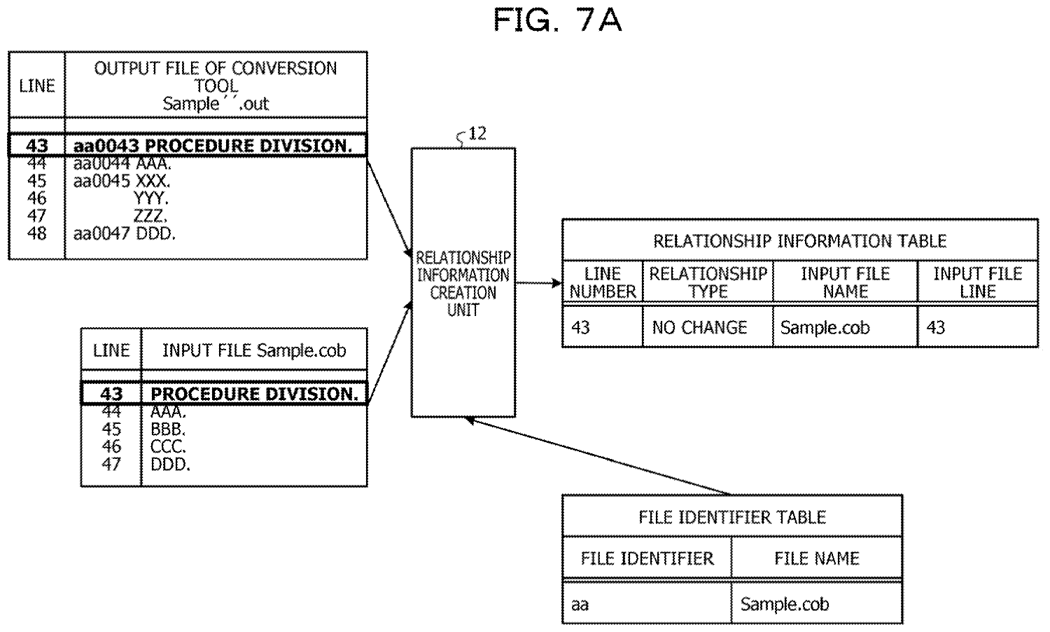

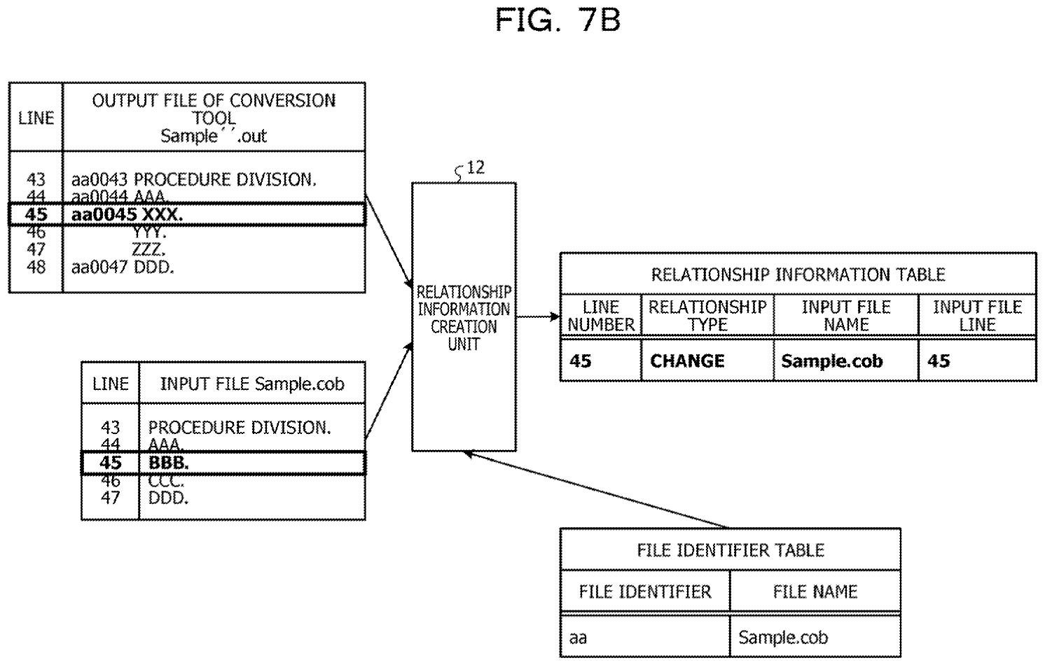

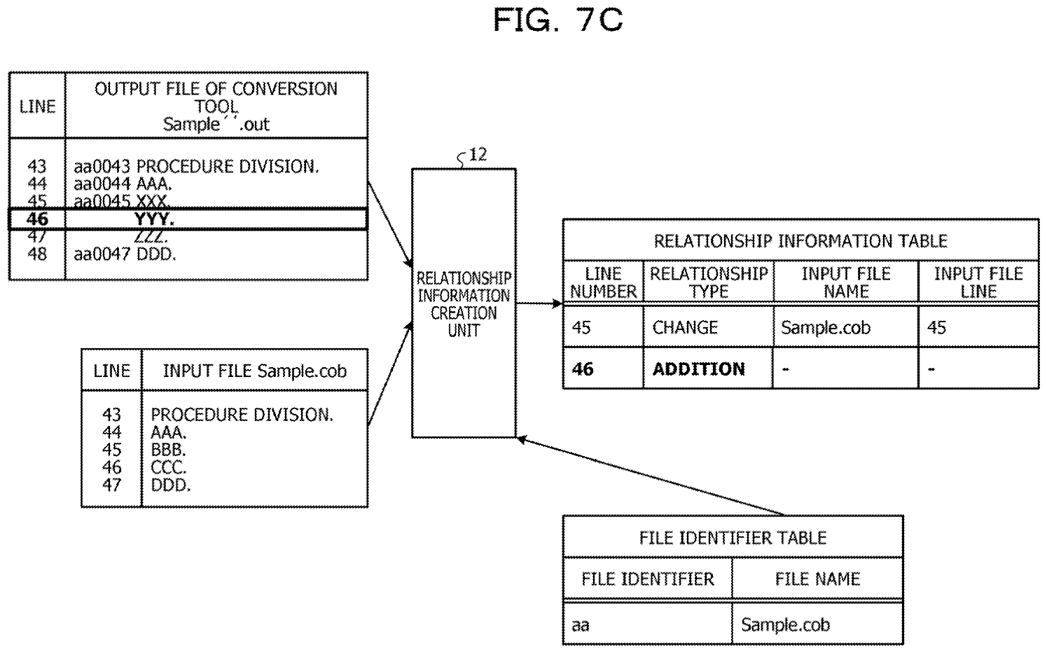

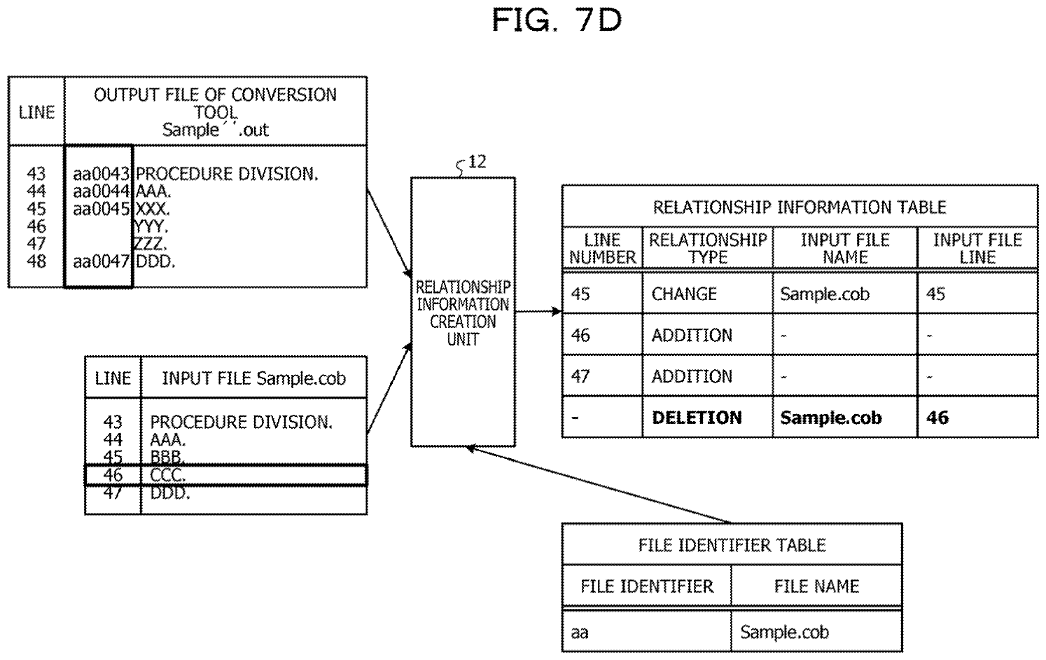

FIGS. 7A to 7D are diagrams illustrating details of creating the relationship information table illustrated in FIG. 6. FIG. 7A illustrates a case where there is no change. As illustrated in FIG. 7A, the relationship information creation unit 12 reads the 43rd line of the output file Sample″.out of the conversion tool 2 and acquires the input line identifier “aa0043”. Then, the relationship information creation unit 12 analyzes the input line identifier “aa0043” and specifies the file identifier “aa” and the line number “0043”. Subsequently, the relationship information creation unit 12 refers to the file identifier table and acquires the name of the file “Sample.cob” corresponding to the file identifier “aa”.

Thereafter, the relationship information creation unit 12 refers to the 43rd line of the input file Sample.cob to compare the contents of the line excluding the line number area with the contents of the 43rd line of the output file Sample“.out excluding the line number area. Then, since the contents of the two lines match in “PROCEDURE DIVISION.”, the relationship information creation unit 12 registers the relationship type in the relationship information table as “no change”. The relationship information creation unit 12 registers the relationship type “no change” in the relationship information table in association with the line number “43” of “Sample”.out”, the input file name “Sample.cob”, and the line number “43” of the input file Sample.cob. Note that this entry is omitted in FIG. 6.

FIG. 78 illustrates a case where there is a change. As illustrated in FIG. 7B, the relationship information creation unit 12 reads the 45th line of the output file Sample″.out of the conversion tool 2 and acquires the input line identifier “aa0045”. Then, the relationship information creation unit 12 analyzes the input line identifier “aa0045” and specifies the file identifier “aa” and the line number “0045”. Subsequently, the relationship information creation unit 12 refers to the file identifier table and acquires the file name “Sample.cob” corresponding to the file identifier “aa”.

Thereafter, the relationship information creation unit 12 refers to the 45th line of the input file Sample.cob to compare the contents of the line excluding the line number area with the contents of the 45th line of the output file Sample″.out excluding the line number area. Then, since the contents of the two lines differ between “BBB” and “XXX”, the relationship information creation unit 12 registers the relationship type in the relationship information table as “change”. The relationship information creation unit 12 registers the relationship type “change” in the relationship information table in association with the line number “45” of the output file Sample″.out, the input file name “Sample.cob”, and the line number “45” of the input file Sample.cob.

FIG. 7C illustrates a case where an addition is made. As illustrated in FIG. 7C, the relationship information creation unit 12 reads the 46th line of the output file Sample″.out of the conversion tool 2 and specifies that there is no input line identifier. Then, the relationship information creation unit 12 determines that the 46th line is a line added by the conversion tool 2, and registers the line number “46” of the output file Sample″.out and the relationship type “addition” in the relationship information table in association with each other.

FIG. 7D illustrates a case where a deletion is made. As illustrated in FIG. 7D, the relationship information creation unit 12 acquires the line number “46” of the input file Sample.cob. Then, the relationship information creation unit 12 reads all the input line identifiers embedded in the output file Sample″.out of the conversion tool 2, and determines that the line with the line number “46” has been deleted because none of the input line identifiers contains the line number “46”. Subsequently, the relationship information creation unit 12 registers the relationship type “deletion”, the input file name “Sample.cob”, and the line number “46” of the input file Sample.cob in the relationship information table in association with each other.

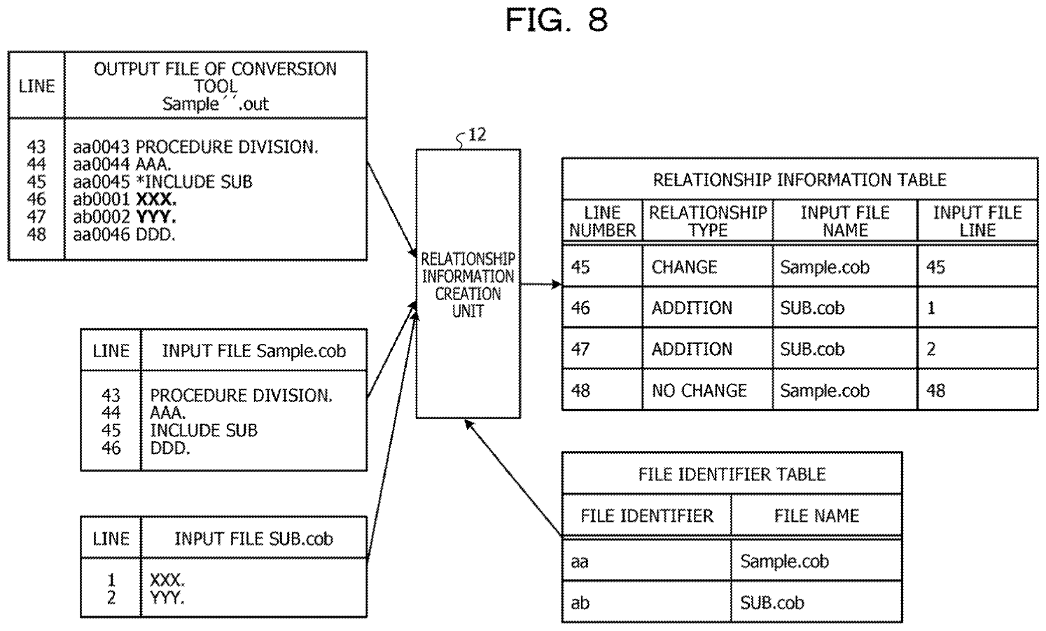

FIG. 8 is a diagram illustrating an example of the relationship information table when the conversion tool 2 expands the contents of a file designated by a macro. As illustrated in FIG. 8, the 45th line of the input file Sample.cob contains a macro (INCLUDE SUB) that expands the contents of an input file SUB.cob.

The line identification information insertion unit 11 allocates a file identifier “ab” to the input file SUB.cob. Then, the line identification information insertion unit 11 registers the file identifier and the file name in the file identifier table in association with each other. Subsequently, the line identification information insertion unit 11 inserts “ab0001” and “ab0002” in the line number area of the first line and the line number area of the second line of the input file SUB.cob, respectively.

The conversion tool 2 expands the macro and adds the first line and the second line of the input file SUB.cob to the 46th and 47th lines of the output file Sample″.out, respectively.

The relationship information creation unit 12 specifies the file identifier “ab” from the input line identifier on the 46th line of the output file Sample″.out, and determines that an addition has been made because the file identifier has been altered to “ab”. Then, the relationship information creation unit 12 refers to the file identifier table and specifies the name of the input file “SUB.cob” corresponding to the file identifier “ab”. Subsequently, the relationship information creation unit 12 registers the line number “46” of the output file Sample″.out, the relationship type “addition”, the name of the input file “SUB.cob”, and the line number “1” of the input file SUB.cob in the relationship information table in association with each other.

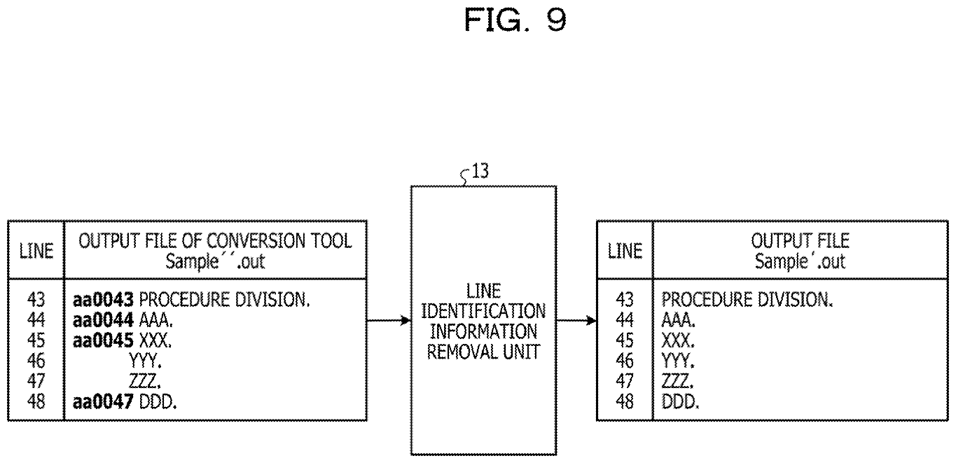

Returning to FIG. 2, the line identification information removal unit 13 reads the post-conversion source code to remove the input line identifiers, and outputs the post-deletion source code. FIG. 9 is a diagram illustrating an example of removing the input line identifiers. In FIG. 9, the output file Sample.out is a file that stores the post-deletion source code. As illustrated in FIG. 9, in the output file Sample′.out, “aa0043”, “aa0044”, “aa0045”, and “aa0047” contained in the line number area of the output file Sample″.out of the conversion tool 2 have been removed.

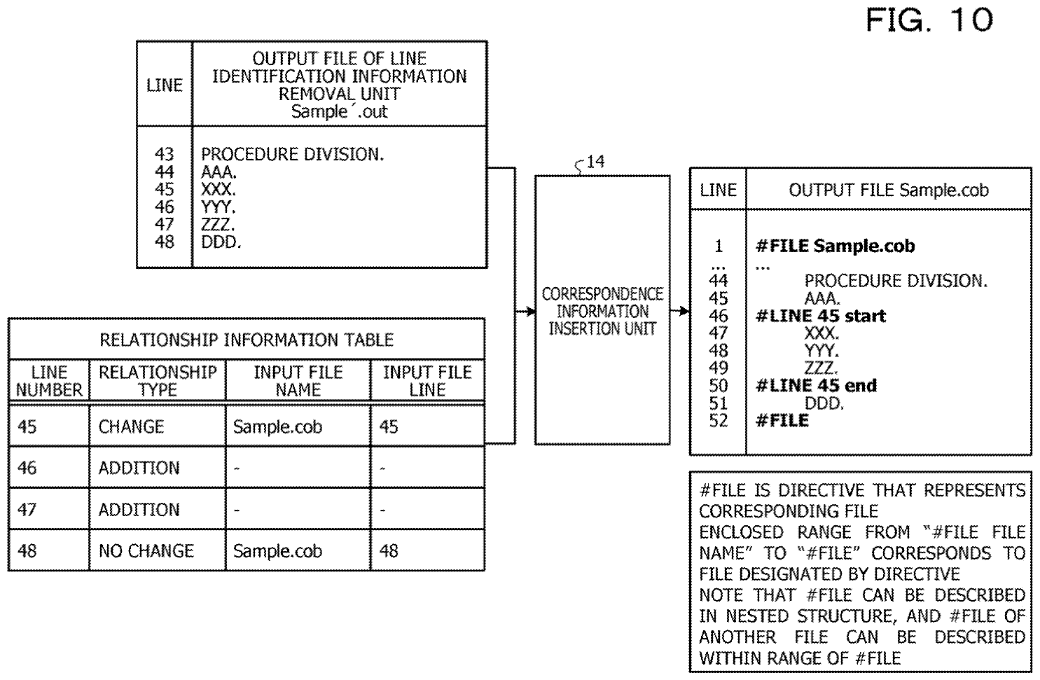

The correspondence information insertion unit 14 inserts the line position correspondence information into the post-deletion source code, based on the relationship information, and outputs the post-insertion source code. FIG. 10 is a diagram illustrating an example of output of the correspondence information insertion unit 14. In FIG. 10, the output file Sample.out is a file that stores the post-insertion source code. As illustrated in FIG. 10, in the output file Sample.out, “#LINE 45 start” and “#LINE 45 end” are inserted as the line position correspondence information.

In FIG. 10, #FILE is a directive that represents the corresponding file. The enclosed range from “#FILE file name” to “#FILE” corresponds to the file designated by the directive. Note that #FILE can be described in a nested structure, and #FILE of another file can be described within the range of #FILE.

The correspondence information insertion unit 14 reads the 45th line of the output file Sample.out of the line identification information removal unit 13, and since this is a case where the read line matches the line number in the relationship information table and the relationship type is “change”, outputs “#LINE 45 start” to the output file Sample.out. Then, the correspondence information insertion unit 14 outputs the 45th line of the output file Sample′.out of the line identification information removal unit 13 to the output file Sample.out.

Subsequently, the correspondence information insertion unit 14 reads the 46th line of the output file Sample′.out of the line identification information removal unit 13. Thereafter, since the read line matches the line number in the relationship information table and the relationship type is “addition”, the correspondence information insertion unit 14 regards the read line as an addition of a line due to the immediately preceding change and outputs the read line to the output file Sample.out. The correspondence information insertion unit 14 performs a process similar to the process for the 46th line also on the 47th line of the output file Sample′.out of the line identification information removal unit 13.

Then, the correspondence information insertion unit 14 reads the 48th line of the output file Sample′.out of the line identification information removal unit 13. Subsequently, the correspondence information insertion unit 14 regards that the line position association has ended because the read line matches the line number in the relationship information table and the relationship type is “no change”, and outputs “#LINE 45 end” to the output file Sample.out.

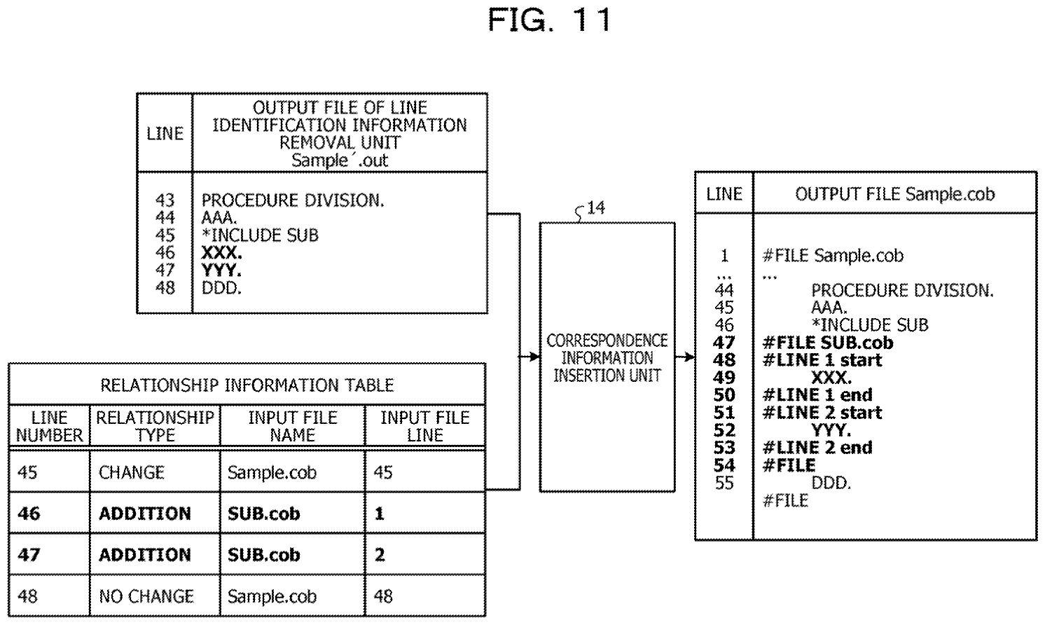

FIG. 11 is a diagram illustrating an example when the contents of the SUB.cob file are expanded. The correspondence information insertion unit 14 reads the 46th line of the output file Sample′.out of the line identification information removal unit 13, and refers to the input file name of an entry whose line number has “46” in the relationship information table. Then, since the input file name is different from the file name in the file correspondence information “#FILE Sample.cob” being output, the correspondence information insertion unit 14 outputs the file correspondence information “#FILE SUB.cob”.

Subsequently, the correspondence information insertion unit 14 outputs the 46th and 47th lines of the output file Sample′.out of the line identification information removal unit 13 to the output file Sample.out together with a #LINE directive. Thereafter, the correspondence information insertion unit 14 reads the 48th line of the output file Sample′.out of the line identification information removal unit 13. Then, since the input file name of an entry whose line number has “48” in the relationship information table is different from the file name in the file correspondence information “#FILE SUB.cob” being output, the correspondence information insertion unit 14 outputs “#FILE” indicating the end of the file correspondence information.

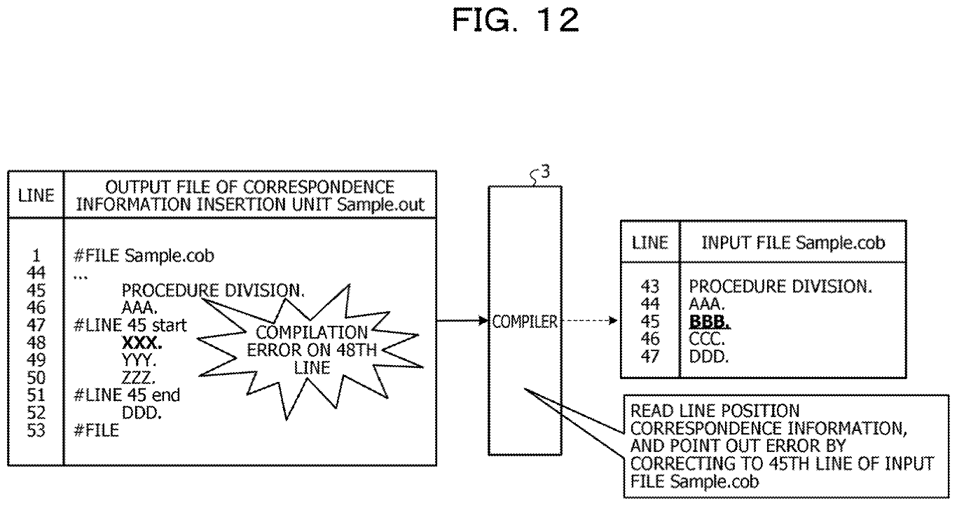

FIG. 12 is a diagram illustrating an example of error display on the input file line by the compiler 3. In FIG. 12, a compilation error occurs on the 48th line of the output file Sample.out of the correspondence information insertion unit 14.

The compiler 3 reads the line position correspondence information “#LINE 45 start” and “#LINE 45 end” before and after the error location, and interprets that the 48th line of the output file Sample.out coincides with the 45th line of the input file Sample.cob. Then, the compiler 3 corrects the location where the error is pointed out to the 45th line of the input file Sample.cob, and points out the error.

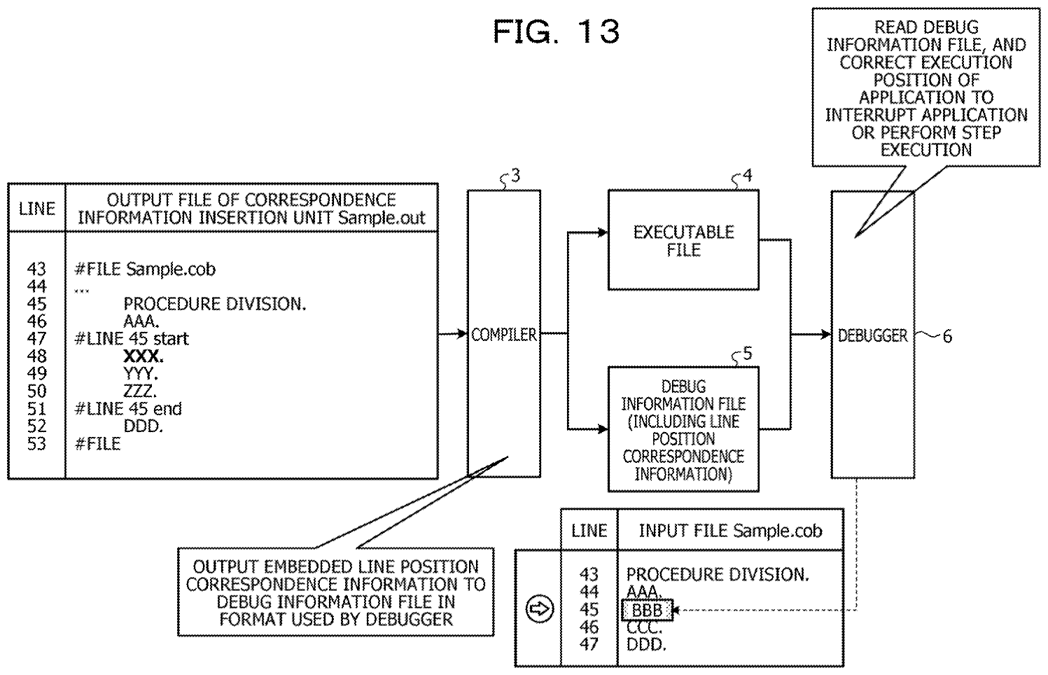

FIG. 13 is a diagram for explaining source code level debugging by a debugger. As illustrated in FIG. 13, in source code level debugging, the compiler 3 outputs the line position correspondence information embedded in the output file Sample.out to a debug information file 5 in a format used by a debugger 6. The debugger 6 reads the debug information file 5 together with an executable file 4, and corrects the execution position of the source code to the execution position of the post-insertion source code to interrupt the execution or perform step execution. In this manner, since the compiler 3 outputs the line position correspondence information to the debug information file 5, debugging at the source code level may be enabled even for a source code converted by the conversion tool 2 that does not output the line position correspondence information.

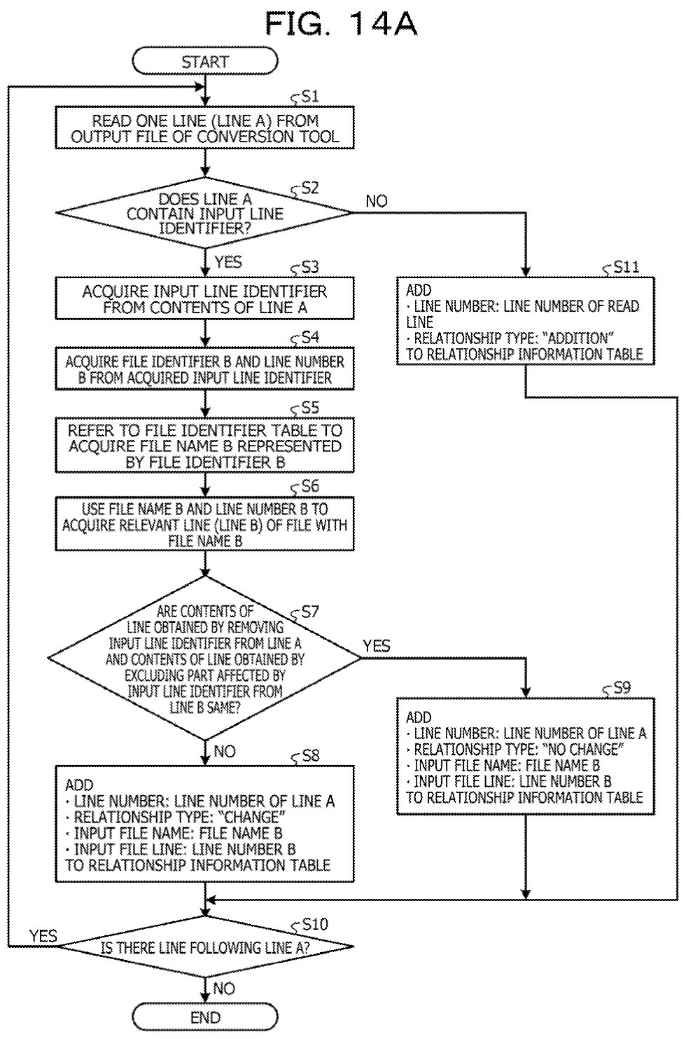

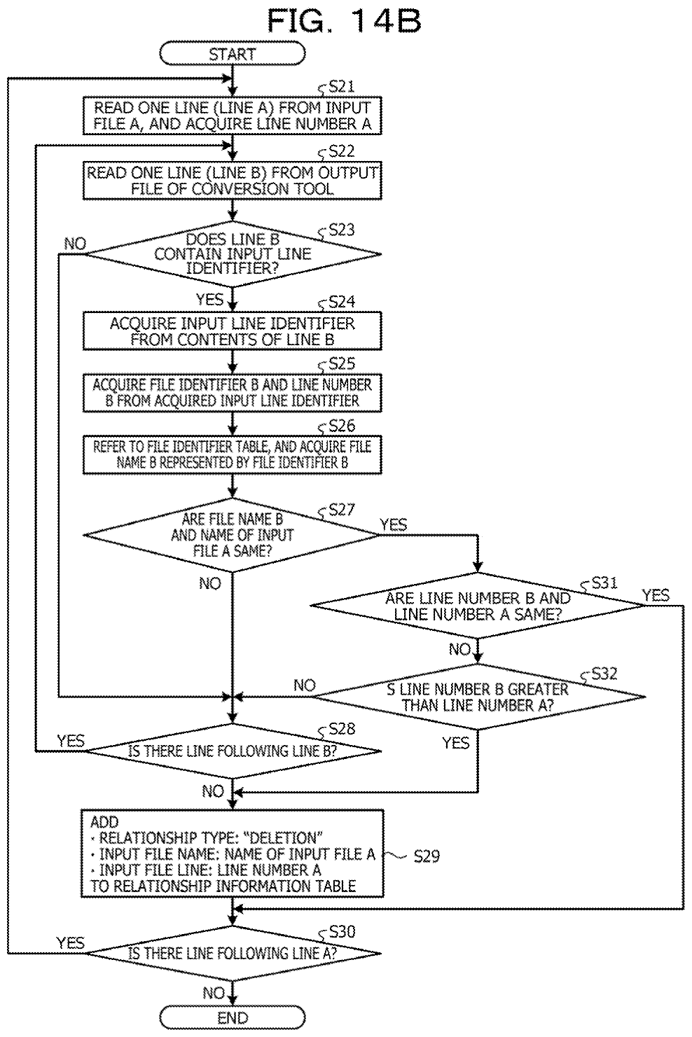

Next, the flow of a process by the relationship information creation unit 12 will be described with reference to FIGS. 14A and 14B. FIGS. 14A and 14B are flowcharts illustrating flows of processes by the relationship information creation unit 12. FIG. 14A illustrates a case where a process other than deletion of a line is performed by the conversion tool 2, and FIG. 14B illustrates a case where deletion of a line is performed by the conversion tool 2. As illustrated in FIG. 14A, the relationship information creation unit 12 reads one line from the output file of the conversion tool 2 (step S1). In FIG. 14A, the line read from the output file of the conversion tool 2 is assumed as a line A.

Then, the relationship information creation unit 12 verifies whether or not the line A contains the input line identifier (step S2), and when the line A contains the input line identifier, acquires the input line identifier from the contents of the line A (step S3). Subsequently, the relationship information creation unit 12 acquires a file identifier B and a line number B from the acquired input line identifier (step S4), and refers to the file identifier table to acquire a file name B represented by the file identifier B (step S5).

Thereafter, the relationship information creation unit 12 uses the file name B and the line number B to acquire the relevant line of a file with the file name B (step S6). In FIG. 14A, the relevant line of the file with the file name B is assumed as a line B. Then, the relationship information creation unit 12 verifies whether or not the contents of the line obtained by removing the input line identifier from the line A and the contents of the line obtained by excluding a part affected by the input line identifier from the line B are the same (step S7).

Subsequently, when the contents of the two are not the same, the relationship information creation unit 12 adds the line number of the line A as the line number, “change” as the relationship type, the file name B as the input file name, and the line number B as the input file line to the relationship information table (step S8). On the other hand, when the contents of the two are the same, the relationship information creation unit 12 adds the line number of the line A as the line number, “no change” as the relationship type, the file name B as the input file name, and the line number B as the input file line to the relationship information table (step S9).

Thereafter, the relationship information creation unit 12 verifies whether or not there is a line following the line A (step S10), and returns to step S1 when there is a following line, while ending the process when there is no following line.

Furthermore, in step S2, when the line A does not contain the input line identifier, the relationship information creation unit 12 adds the line number of the read line as the line number and “addition” as the relationship type to the relationship information table. Then, the relationship information creation unit 12 moves to step S10.

In addition, the relationship information creation unit 12 reads one line from the input file A and acquires a line number A as illustrated in FIG. 148 (step S21). In FIG. 14B, the line read from the input file A is assumed as a line A. Then, the relationship information creation unit 12 reads one line from the output file of the conversion tool 2 (step S22). In FIG. 14B, the line read from the output file of the conversion tool 2 is assumed as a line B.

Subsequently, the relationship information creation unit 12 verifies whether or not the line B contains the input line identifier (step S23), and when the line B does not contain the input line identifier, moves to step 28. On the other hand, when the line B contains the input line identifier, the relationship information creation unit 12 acquires the input line identifier from the contents of the line B (step S24), and acquires the file identifier and a line number B from the acquired input line identifier (step S25).

Thereafter, the relationship information creation unit 12 refers to the file identifier table and acquires a file name B represented by the file identifier (step S26). Then, the relationship information creation unit 12 verifies whether or not the file name B and the name of the input file A are the same (step S27), and when the file name B and the name of the input file A are not the same, verifies whether or not there is a line following the line B (step S28). Subsequently, when there is a line following the line B, the relationship information creation unit 12 returns to step S22.

On the other hand, when there is no line following the line B, the relationship information creation unit 12 adds “deletion” as the relationship type, the name of the input file A as the input file name, and the line number A as the input file line to the relationship information table (step S29). Thereafter, the relationship information creation unit 12 verifies whether or not there is a line following the line A (step S30), and returns to step S21 when there is a following line, while ending the process when there is no following line.

Furthermore, in step S27, when the file name B and the name of the input file A are the same, the relationship information creation unit 12 verifies whether or not the line number B and the line number A are the same (step S31), and moves to step S30 when the line number B and the line number A are the same. On the other hand, when the line number B and the line number A are not the same, the relationship information creation unit 12 verifies whether or not the line number B is greater than the line number A (step S32), and moves to step S29 when the line number B is greater than the line number A, while moving to step S28 when the line number B is not greater than the line number A.

As illustrated in FIGS. 14A and 14B, since the relationship information creation unit 12 creates the relationship information table, the correspondence information insertion unit 14 is allowed to insert the line position correspondence information to the post-deletion source code, based on the relationship information table.

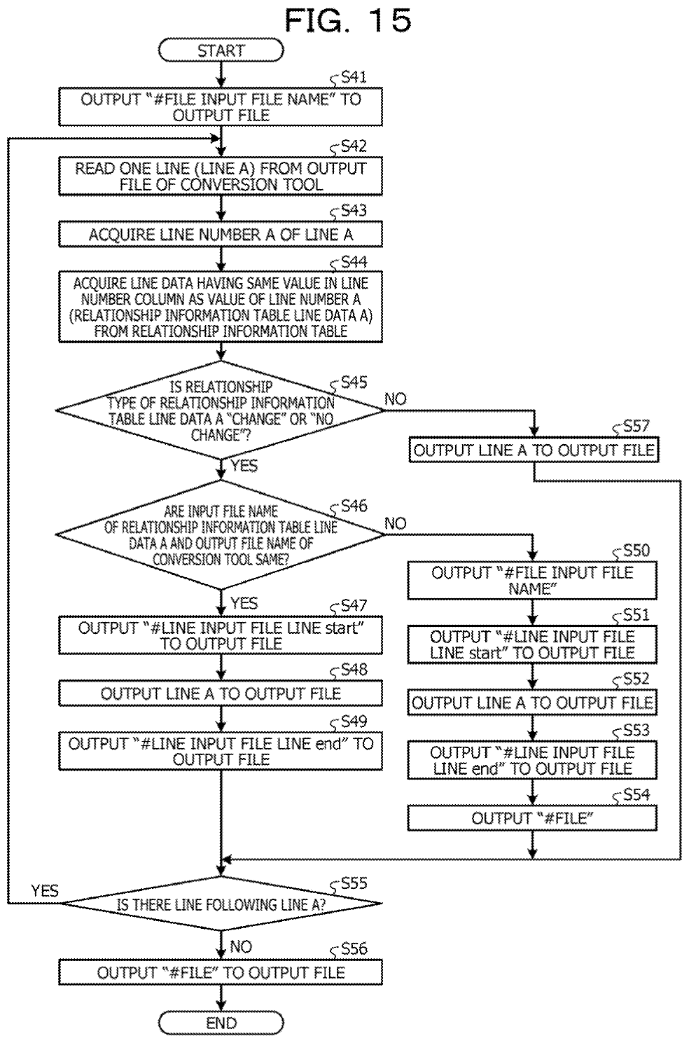

Next, a flow of a process by the correspondence information insertion unit 14 will be described. FIG. 15 is a flowchart illustrating a flow of a process by the correspondence information insertion unit 14. As illustrated in FIG. 15, the correspondence information insertion unit 14 outputs “#FILE input file name” to the output file (step S41), and reads one line from the output file of the conversion tool 2 (step S42). In FIG. 15, the line read from the output file of the conversion tool 2 is assumed as a line A.

Then, the correspondence information insertion unit 14 acquires a line number A of the line A (step S43), and acquires line data having the same value in the line number column as the value of the line number A from the relationship information table (step S44). In FIG. 15, the data acquired from the relationship information table is assumed as relationship information table line data A. Subsequently, the correspondence information insertion unit 14 verifies whether or not the relationship type of the relationship information table line data A is “change” or “no change” (step S45).

Thereafter, when the relationship type of the relationship information table line data A is “change” or “no change”, the correspondence information insertion unit 14 verifies whether or not the input file name of the relationship information table line data A and the output file name of the conversion tool 2 are the same (step S46). Then, when the input file name of the relationship information table line data A and the output file name of the conversion tool 2 are the same, the correspondence information insertion unit 14 outputs “#LINE input file line start” to the output file (step S47). Subsequently, the correspondence information insertion unit 14 outputs the line A to the output file (step S48), and outputs “#LINE input file line end” to the output file (step S49).

On the other hand, when the input file name of the relationship information table line data A and the output file name of the conversion tool 2 are not the same, the correspondence information insertion unit 14 outputs “#FILE input file name” (step S50). Thereafter, the correspondence information insertion unit 14 outputs “#LINE input file line start” to the output file (step S51), and outputs the line A to the output file (step S52). Then, the correspondence information insertion unit 14 outputs “#LINE input file line end” to the output file (step S53), and outputs “#FILE” (step S54).

Subsequently, the correspondence information insertion unit 14 verifies whether or not there is a line following the line A (step S55), and returns to step S42 when there is a following line, while outputting “#FILE” to the output file when where is no following line (step S56).

Furthermore, in step S45, when the relationship type of the relationship information table line data A is neither “change” nor “no change”, the correspondence information insertion unit 14 outputs the line A to the output file (step S57), and moves to step S55.

In this manner, since the correspondence information insertion unit 14 inserts the line position correspondence information, the compiler 3 is allowed to point out the compilation error on the line position of the source code using the line position correspondence information.

As described above, in the embodiment, the line identification information insertion unit 11 embeds the input line identifier in the source code in a form that does not affect the conversion result of the conversion tool 2, and generates the post-embedding source code. Then, the relationship information creation unit 12 generates the relationship information based on the post-conversion source code obtained by converting the post-embedding source code in the conversion tool 2, and the source code. Therefore, the correspondence information insertion unit 14 may be allowed to accurately insert the line position correspondence information, based on the relationship information. Consequently, the conversion assistance device 1 may be allowed to output the post-insertion source code in which the accurate line position correspondence information is inserted.

Furthermore, in the embodiment, the relationship information creation unit 12 appends information that indicates whether or not there is a change, to the relationship information, based on a line A that contains the input line identifier in the post-conversion source code and a line B identified by the same input line identifier in the source code. Therefore, the correspondence information insertion unit 14 may be allowed to accurately insert the line position correspondence information, based on the relationship information regardless of whether the line has been changed or not by the conversion tool 2.

In addition, in the embodiment, for a line that does not contain the input line identifier in the post-conversion source code, the relationship information creation unit 12 appends information that indicates that the line has been added to the source code, to the relationship information. Therefore, the correspondence information insertion unit 14 may be allowed to accurately insert the line position correspondence information, based on the relationship information when a line has been added by the conversion tool 2.

In addition, in the embodiment, the relationship information creation unit 12 appends information that indicates that the line B has been deleted from the source code, to the relationship information, when the input line identifier that identifies the line B of the source code is not contained in the post-conversion source code. Therefore, the correspondence information insertion unit 14 may be allowed to accurately insert the line position correspondence information, based on the relationship information when a line has been deleted by the conversion tool 2.

In addition, in the embodiment, the line identification information removal unit 13 removes the input line identifier from the post-conversion source code to generate the post-deletion source code, and the correspondence information insertion unit 14 inserts the line position correspondence information to the post-deletion source code to generate the post-insertion source code. Consequently, the conversion assistance device 1 may be allowed to generate the post-insertion source code that does not contain the input line identifier.

In addition, in the embodiment, the input line identifier contains the file identifier, and the relationship information creation unit 12 appends information that indicates that a line whose file identifier is different from the file identifier of a preceding line in the post-conversion source code is a line added from another source code, to the relationship information. Therefore, the correspondence information insertion unit 14 may be allowed to insert information used to specify the input file, based on the relationship information.

Note that, in the embodiment, the conversion assistance device 1 has been described. However, by implementing the components included in the conversion assistance device 1 by software, a conversion assistance program that has a similar function may be obtained. Thus, a computer that executes the conversion assistance program will be described.

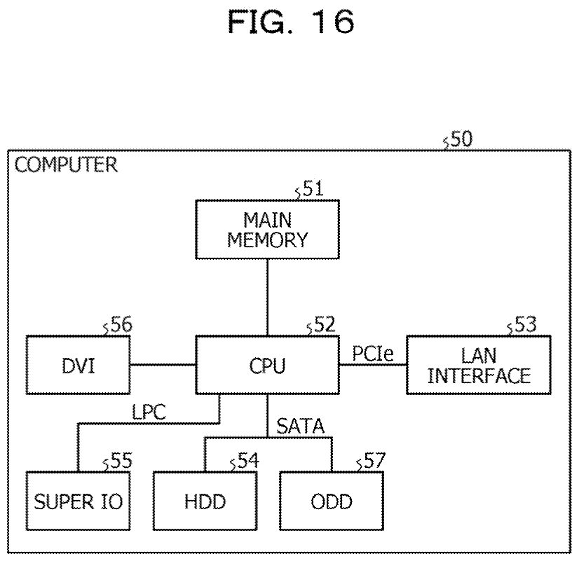

FIG. 16 is a diagram illustrating a hardware configuration of a computer that executes the conversion assistance program according to the embodiment. As illustrated in FIG. 16, a computer 50 includes a main memory 51, a central processing unit (CPU) 52, a local area network (LAN) interface 53, and a hard disk drive (HDD) 54. Furthermore, the computer 50 includes a super input output (IO) 55, a digital visual interface (DVI) 56, and an optical disk drive (ODD) 57.

The main memory 51 is a memory that stores a program, a halfway result of execution of the program, and the like. The CPU 52 is a central processing unit that reads and executes the program from the main memory 51. The CPU 52 includes a chipset having a memory controller.

The LAN interface 53 is an interface for connecting the computer 50 to another computer by way of a LAN. The HDD 54 is a disk device that stores programs and data, and the super IO 55 is an interface for connecting an input device such as a mouse and a keyboard. The DVI 56 is an interface that connects a liquid crystal display device, and the ODD 57 is a device that reads and writes data from and to a digital versatile disc (DVD).

The LAN interface 53 is connected to the CPU 52 by peripheral component interconnect express (PCIe), and the HDD 54 and the ODD 57 are connected to the CPU 52 by serial advanced technology attachment (SATA). The super IO 55 is connected to the CPU 52 by low pin count (LPC).

Then, the conversion assistance program executed by the computer 50 is stored in a DVD that is an example of a recording medium that can be read by the computer 50, and is read from the DVD by the ODD 57 to be installed to the computer 50. Alternatively, the conversion assistance program is stored in a database and the like of another computer system connected via the LAN interface 53, and is read from these databases to be installed to the computer 50. Subsequently, the installed conversion assistance program is stored in the HDD 54, is read to the main memory 51, and is executed by the CPU 52.

Furthermore, in the embodiment, the conversion tool 2 and the conversion assistance device 1 have been described, but one device may have both of the functions of the conversion tool 2 and the functions of the conversion assistance device 1 as a conversion device.

In addition, in the embodiment, a case where “change” and “no change”, and “addition” and “deletion” are included has been described, but the relationship types only need to include at least one of “change” and “no change”, and “addition” and “deletion”.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable medium storing a conversion assistance program that causes at least one computer to execute a process, the process comprising:
embedding an identifier that identifies a line position of a code line of a source code in the source code, in a form that does not affect a conversion result of a conversion tool that converts the source code; and
generating relationship information based on the source code and a post-conversion source code generated by converting, using the conversion tool, a post-embedding source code which is the source code after the identifier is embedded, the relationship information indicating at least one of whether or not there is a change from the code line of the source code to the code line of the post-conversion source code and an addition of the code line to the source code and a deletion of the code line from the source code.

2. The non-transitory computer-readable medium according to claim 1, wherein
based on a first code line that includes the identifier in the post-conversion source code and a second code line identified by the identifier in the source code, the generating includes generating the relationship information that indicates whether or not there is the change from the second code line to the first code line.

3. The non-transitory computer-readable medium according to claim 1, wherein
when a third code line does not include the identifier in the post-conversion source code, the generating includes generating the relationship information that indicates that the third code line has been added to the source code.

4. The non-transitory computer-readable medium according to claim 1, wherein
when the post-conversion source code does not include the identifier that identifies the line position of a fourth code line of the source code, the generating includes generating the relationship information that indicates that the fourth code line has been deleted from the source code.

5. The non-transitory computer-readable medium according to claim 2, wherein the process further comprising:
inserting information regarding the line position of the second code line before the first code line, when the relationship information indicates that there is the change.

6. The non-transitory computer-readable medium according to claim 2, wherein the process further comprising:
deleting the identifier from the post-conversion source code to generate a post-deletion source code; and
inserting the information regarding the line position of the second code line before the code line that corresponds to the first code line, in the post-deletion source code, when the relationship information indicates that there is the change.

7. The non-transitory computer-readable medium according to claim 1, wherein the identifier embedded by the embedding includes a file identifier that identifies a file that stores the source code, and
when the file identifier contained in a fifth code line that includes the identifier in the post-conversion source code is different from the file identifier contained in a preceding code line, the generating generates the relationship information that indicates that the fifth cede line has been added from another source code.

8. A conversion assistance method for at east one computer to execute a process comprising:
embedding an identifier that identifies a line position of a code line of a source code in the source code, in a form that does not affect a conversion result of a conversion tool that converts the source code; and
generating relationship information based on the source code and a post-conversion source code generated by converting, using the conversion tool, a post-embedding source code which is the source code after the identifier is embedded, the relationship information indicating at least one of whether or not there is a change from the code line of the source code to the code line of the post-conversion source code and an addition of the code line to the source code and a deletion of the code line from the source code.

9. The conversion assistance method according to claim 8, wherein
based on a first code line that includes the identifier in the post-conversion source code and a second code line identified by the identifier in the source code, the generating includes generating the relationship information that indicates whether or not there is the change from the second code line to the first code line.

10. The conversion assistance method according to claim 8, wherein
when a third code line does not include the identifier in the post-conversion source code, the generating includes generating the relationship information that indicates that the third code line has been added to the source code.

11. The conversion assistance method according to claim 8, wherein
when the post-conversion source code does not include the identifier that identifies the line position of a fourth code line of the source code, the generating includes generating the relationship information that indicates that the fourth code line has been deleted from the source code.

12. The conversion assistance method according to claim 9, wherein the process further comprising:
inserting information regarding the line position of the second code line before the first code line, when the relationship information indicates that there is the change.

13. The conversion assistance method according to claim 9, wherein the process further comprising:
deleting the identifier from the post-conversion source code to generate a post-deletion source code; and
inserting the information regarding the line position of the second code line before the code line that corresponds to the first code line, in the post-deletion source code, when the relationship information indicates that there is the change.

14. The conversion assistance method according to claim 8, wherein the identifier embedded by the embedding includes a file identifier that identifies a file that stores the source code, and
when the file identifier contained in a fifth code line that includes the identifier in the post-conversion source code is different from the file identifier contained in a preceding code line, the generating generates the relationship information that indicates that the fifth code line has been added from another source code.

15. A conversion assistance device comprising:
one or more memories; and
one or more processors coupled to the one or more memories and the one or more processors configured to
embed an identifier that identifies a line position of a code line of a source code in the source code in a form that does not affect a conversion result of a conversion tool that converts the source code; and
generating relationship information based on the source code and a post-conversion source code generated by converting, using the conversion tool, a post-embedding source code which is the source code after the identifier is embedded, the relationship information indicating at least one of whether or not there is a change from the code line of the source code to the code line of the post-conversion source code and an addition of the code line to the source code and a deletion of the code line from the source code.

16. The conversion assistance device according to claim 15, wherein
based on a first code line that includes the identifier in the post-conversion source code and a second code line identified by the identifier in the source code, the generating includes generating the relationship information that indicates whether or not there is the change from the second code line to the first code line.

17. The conversion assistance device according to claim 15, wherein
when a third code line does not include the identifier in the post-conversion source code, the generating includes generating the relationship information that indicates that the third code line has been added to the source code.

18. The conversion assistance device according to claim 15, wherein
when the post-conversion source code does not include the identifier that identifies the line position of a fourth code line of the source code, the generating includes generating the relationship information that indicates that the fourth code line has been deleted from the source code.

19. The conversion assistance device according to claim 15, the one or more processors further configured to
insert information regarding the line position of the second code line before the first code line, when the relationship information indicates that there is the change.

20. The conversion assistance device according to claim 15, the one or more processors further configured to
delete the identifier from the post-conversion source code to generate a post-deletion source code; and
insert the information regarding the line position of the second code line before the code line that corresponds to the first code line, in the post-deletion source code, when the relationship information indicates that there is the change.
